(19) United States
(12) Patent Application Publication
(10) Pub. No.: US 2006/0151997 A1
(43) Pub. Date: Jul. 13, 2006

(54) High-pressure fastening tee assembly

(76) Inventors: Jared Sayers, Red Deer (CA); Amanjeet Dhaliwal, Red Deer (CA); David Ebl, Condor (CA)

Correspondence Address: SANDER R. GEISING, 600, 4911-51 STREET, RED DEER, AB, T4N-6V4, CA

(21) Appl. No.: 11/311,481

(22) Filed: Dec. 20, 2005

Related U.S. Application Data
(60) Provisional application No. 60/637,729, filed on Dec. 22, 2004.

(30) Foreign Application Priority Data
Dec. 22, 2004 (CA) 2,490,943

(51) Int. Cl. F16L 41/00

(52) U.S. Cl. 285/197; 285/133.11; 285/419

(57) ABSTRACT

In one aspect, the invention provides a fastening tee assembly for use on a conduit, the conduit generally having pressurized contents, the assembly comprising a first shell having a port therethrough, a second shell, fastening means to fasten said first and second shells around the conduit, a pressure carrying branch suitable for insertion through the first shell's port and having a sealing end and an inside passage, said inside passage suitable for accepting a drill or hot tap machine therethrough, a seal suitable for creating a sealing engagement between the pressure carrying branch's sealing end and the conduit, and engagement means to maintain the sealing engagement between the pressure carrying branch's sealing end and the conduit. A method aspect is also provided.

### CROSS REFERENCE TO RELATED APPLICATION

This application is a regular application of U.S. Provisional Patent Application Ser. No. 60/637,729 filed Dec. 22, 2004 and entitled, “HIGH-PRESSURE FASTENING TEE ASSEMBLY”, the entirety of which is incorporated herein by reference.

### FIELD OF THE INVENTION

The field of present invention relates generally to providing a high-pressure fastening tee assembly and, more particularly, to providing a high-pressure fastening tee assembly having improved sealing means.

### BACKGROUND OF THE INVENTION

Fastening tee assemblies, sometimes simply referred to as clamps, are typically used when hot tapping into high-pressured piping systems, such as gas pipelines, drill string, coil tubing or other such conduit, without the need for welding.

However, traditional fastening tee assemblies employ inferior sealing technology, are expensive to manufacture and are heavy. The prior art typically provides sealing means in the form of an o-ring or rubber gasket on the inside of the top shell of such a tee assembly (see FIG. 1), said o-ring or gasket positioned around an aperture in the top shell so as to be compressed against the conduit or pipeline when the top and bottom shells are assembled together around said conduit. A valve is then attached or threaded to the top shell's aperture and a drill or hot tap machine is then inserted through the valve and said aperture so as to drill into the conduit while maintaining pressure.

Unfortunately this prior art sealing technology (i.e. an o-ring seal around the aperture and positioned on the inside of a top shell) limits the amount of pressure that such a fastening tee assembly is able to withstand. A typical upper pressure rating for such prior art fastening tee assemblies is 1500 psi.

An advantage therefore exists for a fastening tee assembly to have better sealing means.

### SUMMARY OF THE INVENTION

In one aspect, the invention provides a fastening tee assembly for use on a conduit, the conduit generally having pressurized contents, the assembly comprising a first shell having a port therethrough, a second shell, fastening means to fasten said first and second shells around the conduit, a pressure carrying branch suitable for insertion through the first shell's port and having a sealing end and an inside passage, said inside passage suitable for accepting a drill or hot tap machine therethrough, a seal suitable for creating a sealing engagement between the pressure carrying branch's sealing end and the conduit, and engagement means to maintain the sealing engagement between the pressure carrying branch's sealing end and the conduit.

In a method aspect the invention provides a method of creating a seal between a conduit and a tubular member, said conduit having a pressurized contents and said tubular member having a sealing end. The method comprises the steps of providing at least one shell suitable for engaging the conduit, said shell having a port therethrough, providing a seal suitable for creating a sealing engagement between the tubular member's sealing end and the conduit, fastening the shell against the conduit, inserting the seal and the tubular member through the port so that the seal is positioned between the conduit and the tubular member's sealing end, creating a sealing engagement between the tubular member's sealing end and the conduit and maintaining said sealing engagement for a desired length of time.

### BRIEF DESCRIPTION OF THE DRAWINGS

FIG. 1 is a perspective view of a top shell of a prior art fastening tee assembly, showing the placement of the sealing gasket or o-ring;

FIGS. 2-4 are various views of a first embodiment of a fastening tee assembly of the present invention;

FIGS. 5-11 are various views of a second embodiment of a fastening tee assembly of the present invention; and

FIGS. 12-24d are various views of a third embodiment of a fastening tee assembly of the present invention.

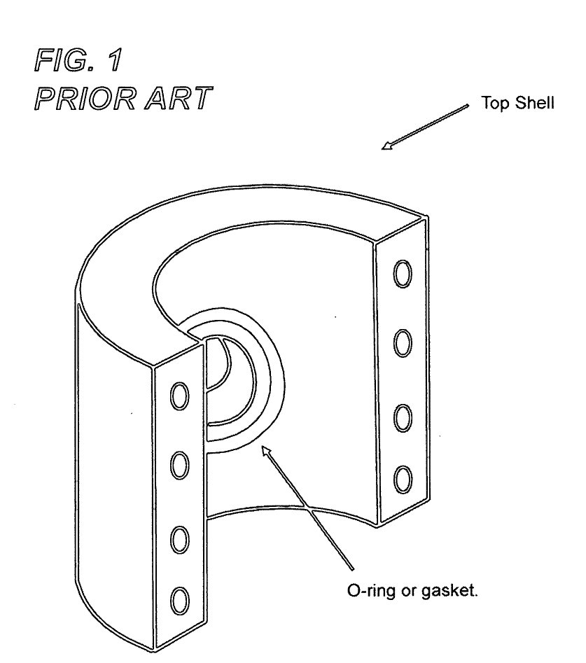

### DETAILED DESCRIPTION OF THE PREFERRED EMBODIMENTS

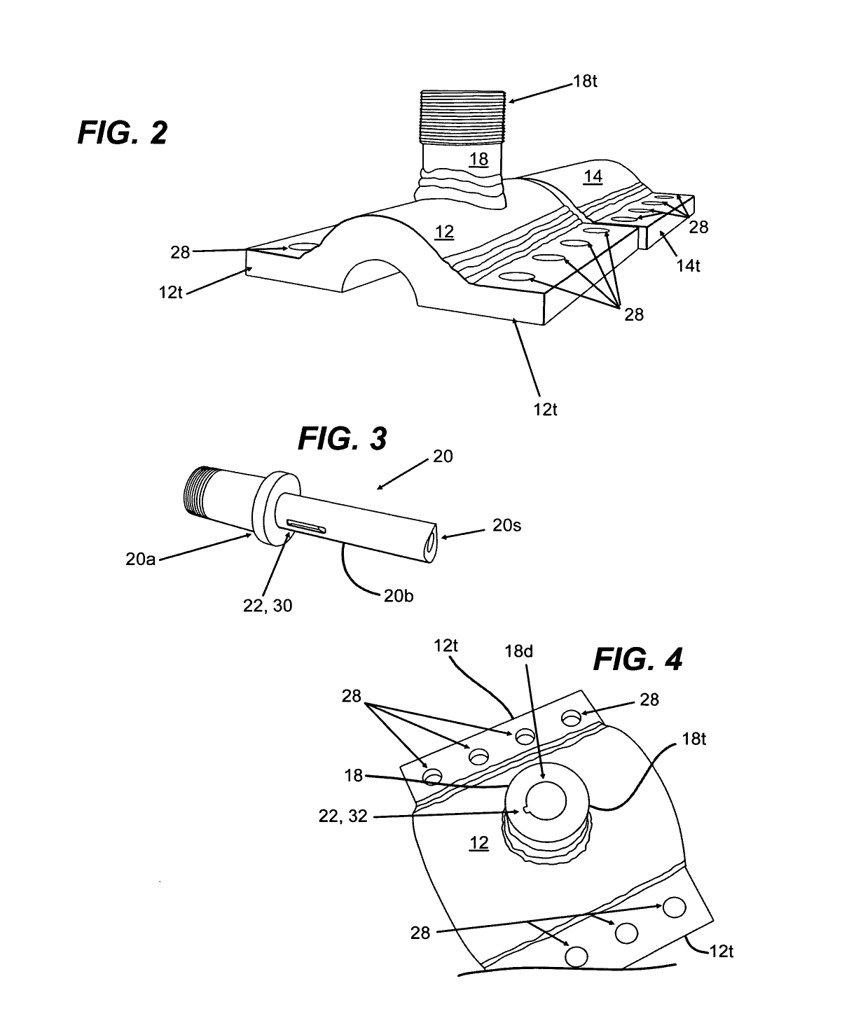

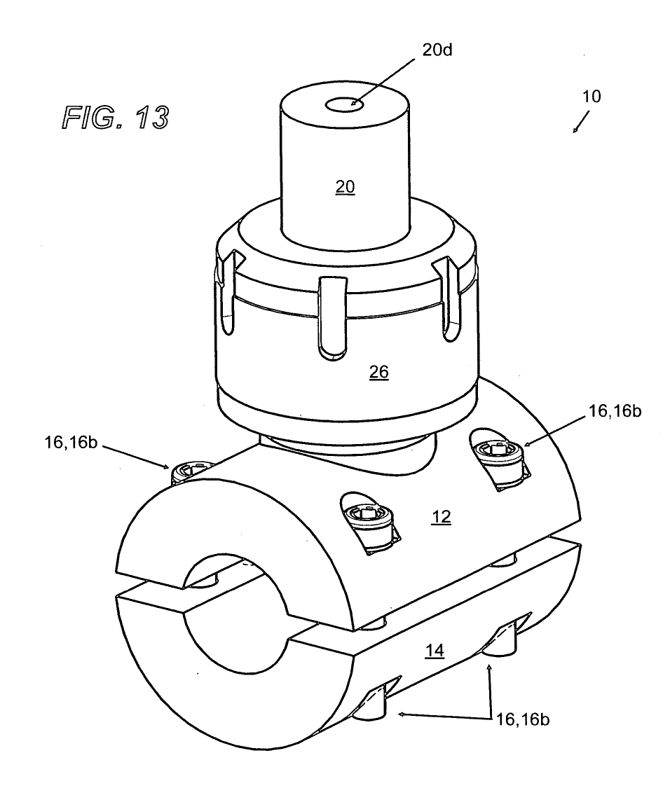

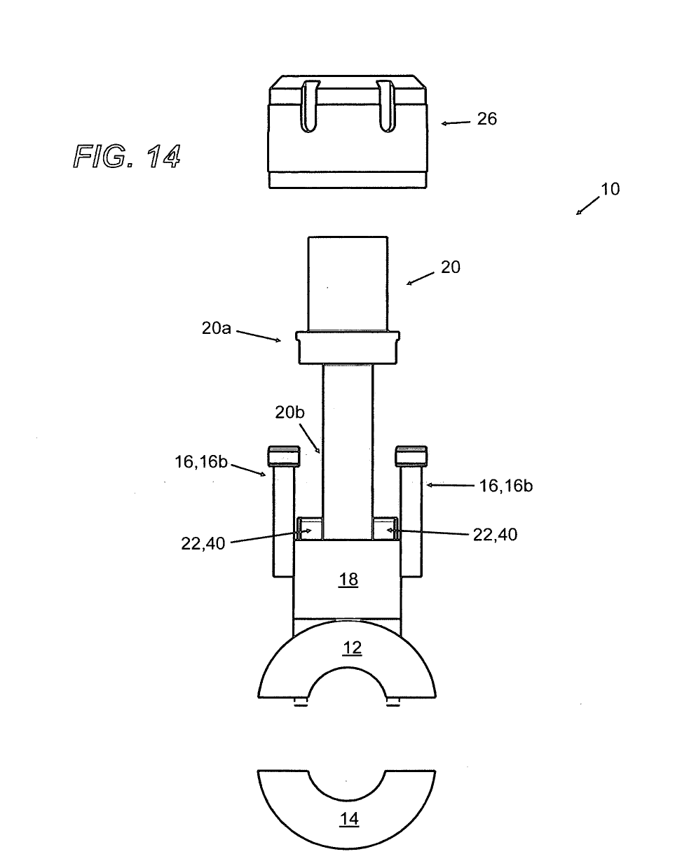

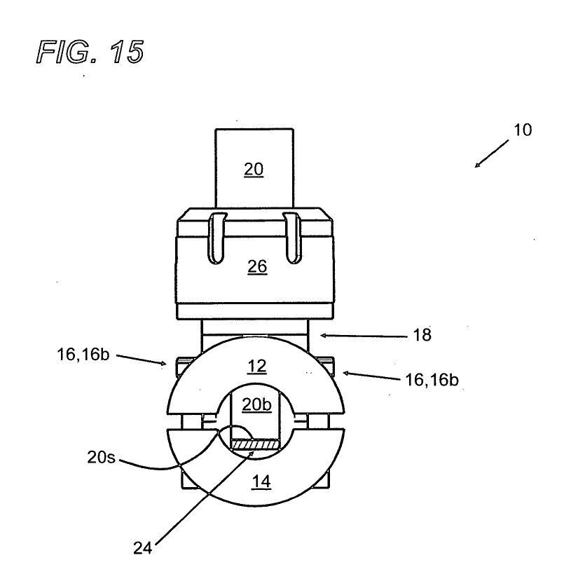

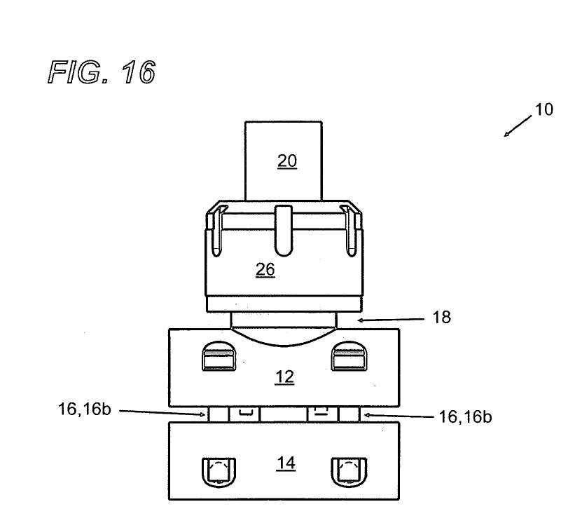

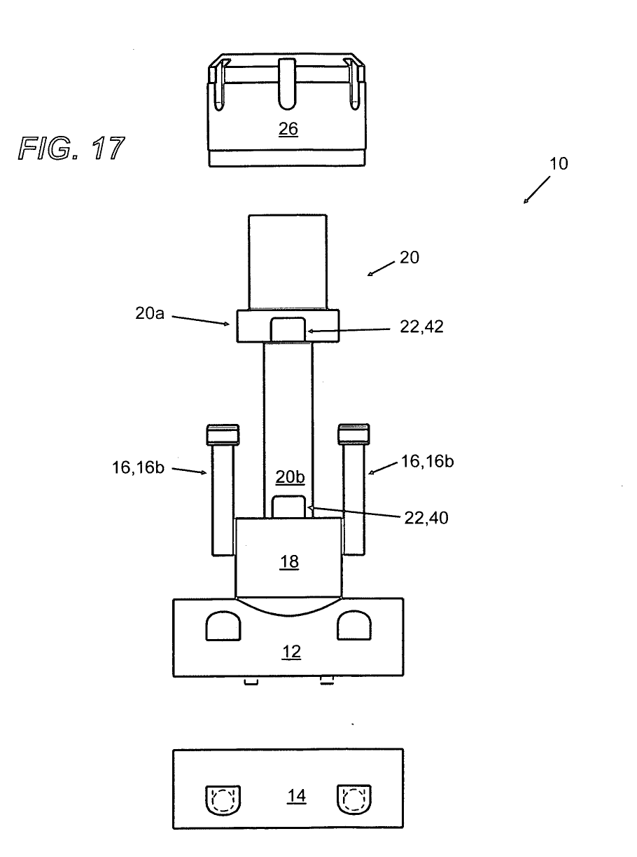

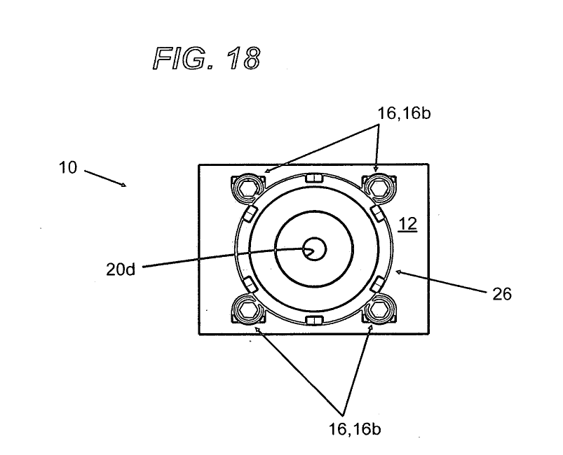

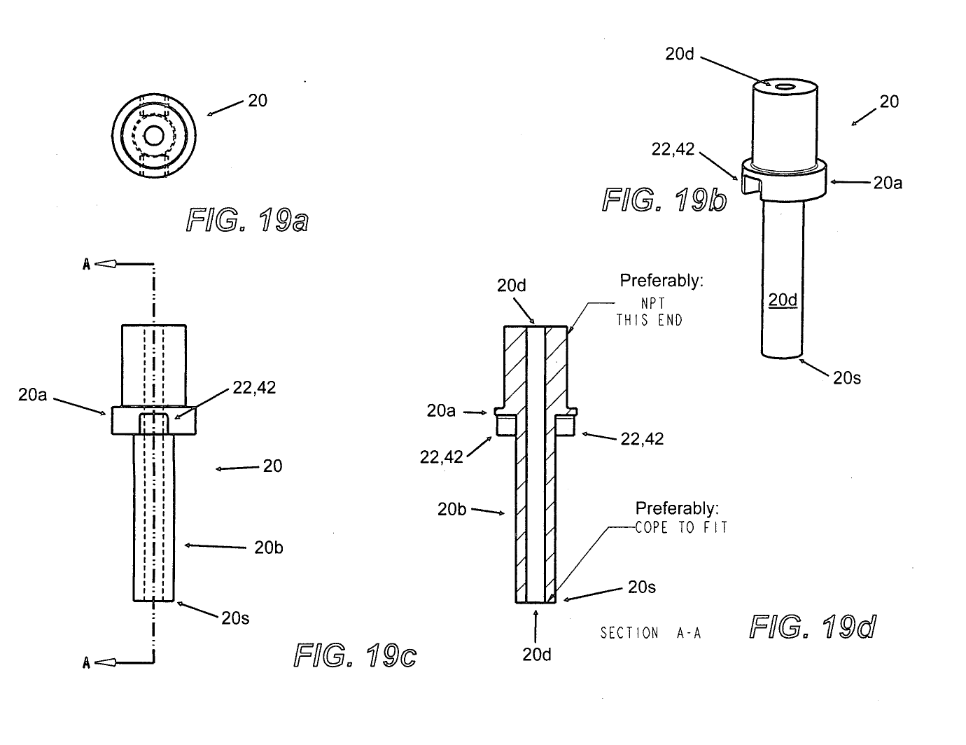

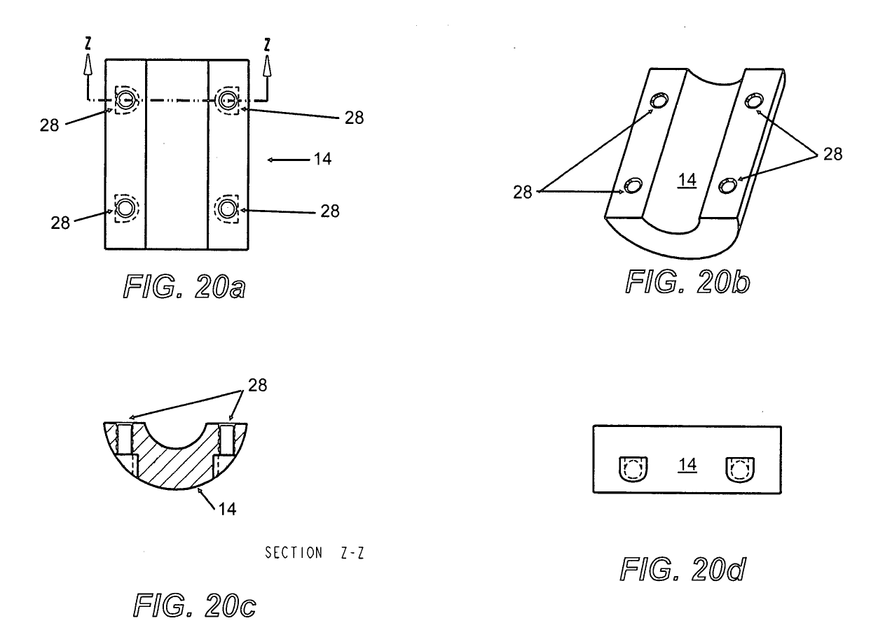

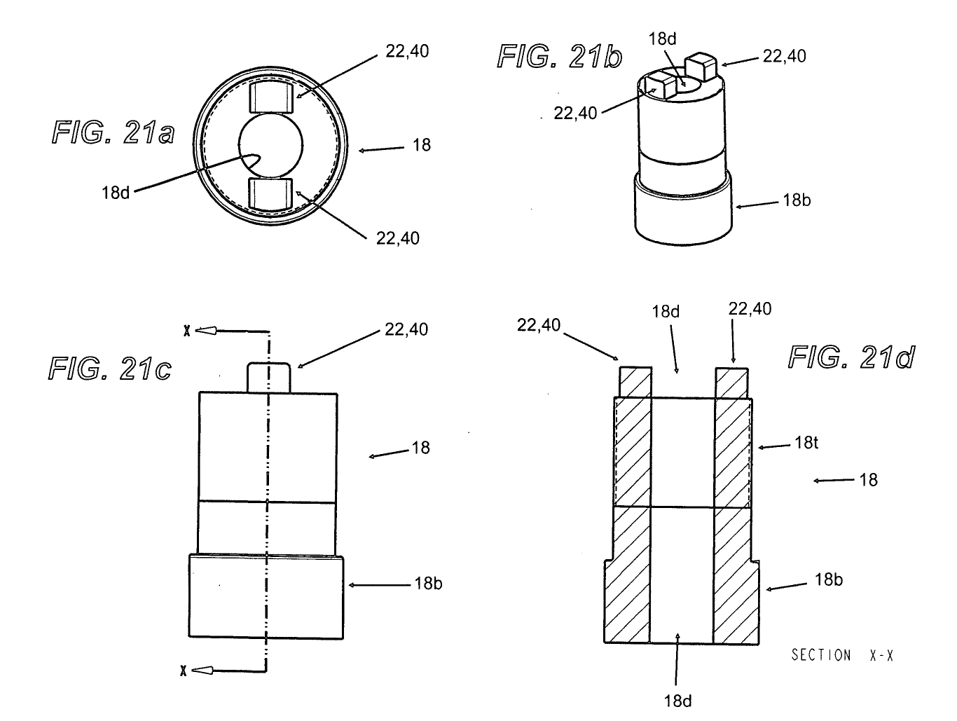

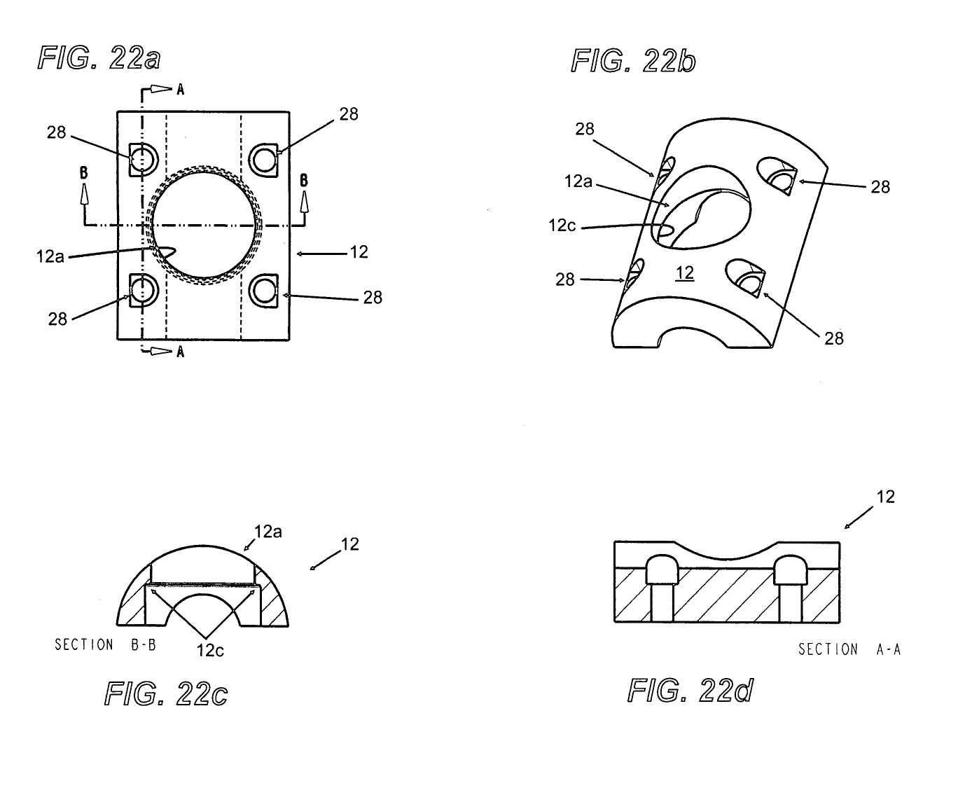

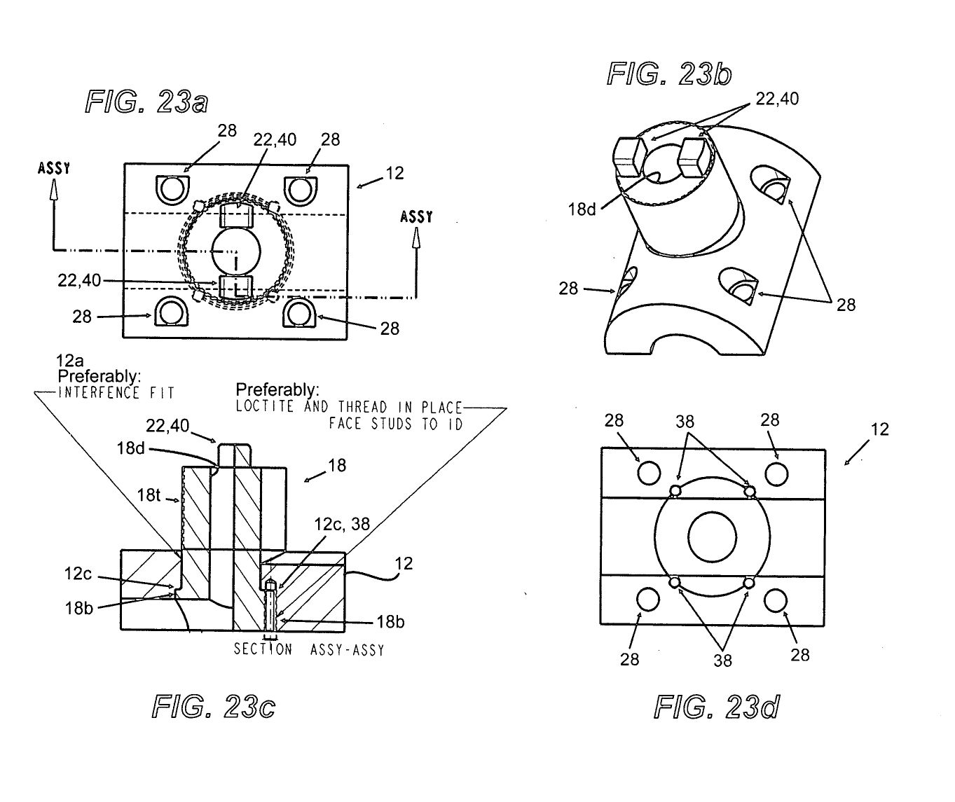

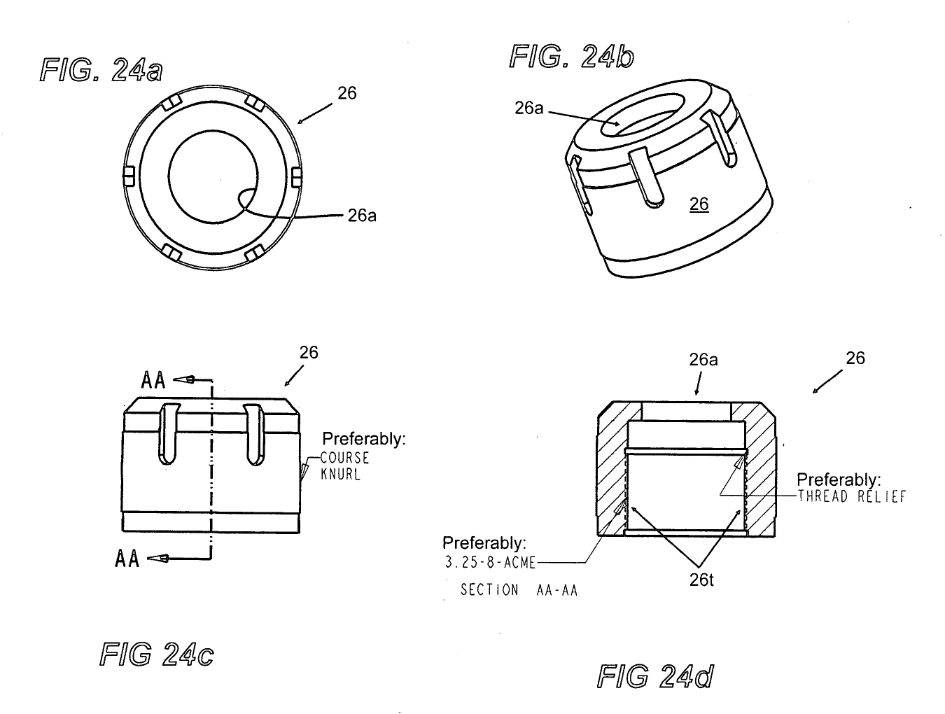

Reference is to be had to FIGS. 2-24d in which identical reference numbers identify similar components.

Referring generally to FIGS. 2-24d, various embodiments of a fastening tee assembly 10 of the present invention are shown. These various embodiments of the fastening tee assembly 10 comprise paired shells 12, 14 (hereinafter referred to as top and bottom shells 12, 14, although the orientation may vary during installation or operation and is not an essential feature of the invention), fastening means 16, a non-pressure branch or neck 18 projecting from the top shell 12, a pressure carrying branch 20 having a sealing end 20s (said end 20s preferably coped to match the outer diameter of the conduit), a seal 24 suitable for sealing engagement between the pressure carrying branch's sealing end 20s and the conduit (not shown), and a locking or compressing collar 26 preferably having an internally threaded portion 26t. Preferably the assembly 10 further comprises anti-rotation means 22 to prevent the pressure carrying branch 20 from rotating axially relative to the non-pressure branch 18.

The non-pressure branch 18 preferably is a cylindrical tube having a threaded end 18t suitable to threadably engage the locking collar's threaded portion 26t. The non-pressure branch 18 further comprises an internal diameter or port 18d for accepting the pressure carrying branch 20 and the seal 24 therethrough, preferably at close tolerances. The non-pressure branch 18 may be an integral part of the top shell 12 (e.g. by being welded thereto) such as in the first embodiment (see FIGS. 2-4), or the non-pressure branch 18 may be a separate component shaped so as to fit with a close tolerance through the top shell 12, such as in the second and third embodiments.

The pressure carrying branch 20 preferably is a cylindrical tube having a shoulder portion 20a and shaft portion 20b. The pressure carrying branch 20 further comprises an internal diameter, passage or port 20d for accepting a hot-tap machine (not shown) or drill (not shown) axially there-through.

The locking collar 26 preferably comprises an aperture 26a of such diameter so as to allow axial passage of the pressure carrying branch 20 there-through, except for the shoulder portion 20a. It will be recognized by those skilled in the art that other configurations of the locking collar 26 are possible, and not depart from the invention, as long as the locking collar 26 functions to force or compress the pressure carrying branch 20 and the seal 24 through the non pressure branch 18 (i.e. through the inside diameter 18d) and against the conduit (not shown).

The top and bottom shells 12, 14 are generally shaped as shown in the Figures and in the conventional manner, so as to mount to high-pressured piping systems, such as gas pipelines, drill strings, coil tubing or other such conduits (not shown). Preferably the top and bottom shells 12, 14 each have a plurality of holes 28 for receiving bolts 16b there-through, so as to fasten the two shells 12, 14 together around a conduit (not shown).

The seal 24 is of the appropriate dimensions so as to seal the pressure carrying branch 20 against the high pressure conduit (not shown), when said branch 20 and the seal 24 are inserted through inside diameter 18d and forced against the conduit (not show). In particular, the seal 24 will create a seal between inside diameter 20d of the pressure branch 20 and the inside diameter 18d of the non pressure branch 18 such that when a drill or hot tap machine (not shown) is advanced through the inside diameter 20d of the pressure branch 20 and cuts through the conduit (not show), any pressurized contents inside the conduit will be allowed into the inside diameter 20d of the pressure branch 20, but will be prevented from escaping into the inside diameter 18d of the non pressure branch 18. Preferably the seal 24 is a rubber seal generally shaped as shown in FIGS. 2 and 9. More preferably, the seal means 24 is constructed from VITON™ rubber manufactured by The Dow Chemicals of Wilmington, Del., U.S.A.

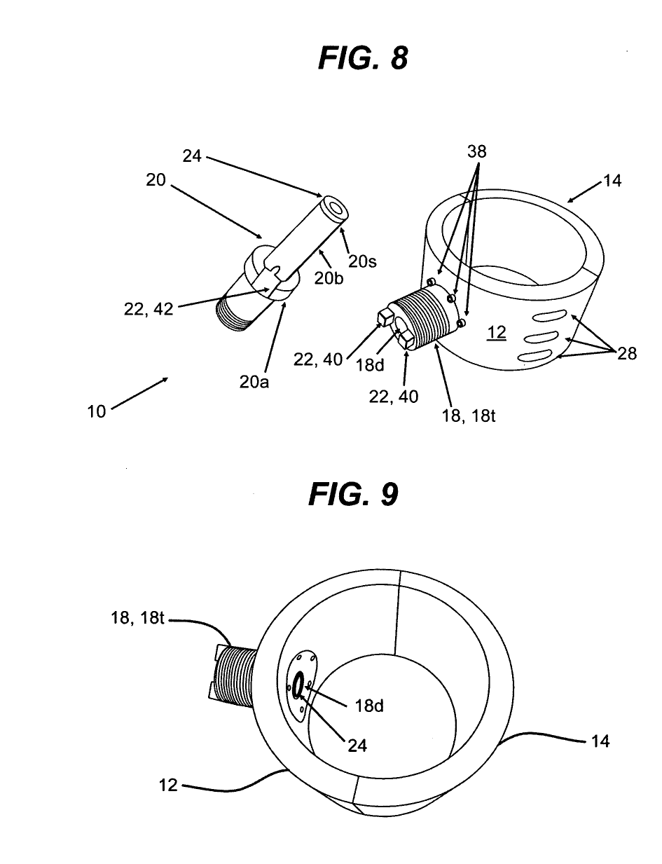

In operation, the shaft portion 20d of the pressure carrying branch 20 slides through the port 18d of the non-pressure branch 18 thereby advancing the sealing end 20s and the seal 24 there-through and against the conduit (not shown), see FIGS. 8-9. The collar 26 is then utilized to clamp the pressure carrying branch 20 down against the conduit (not shown), thereby giving the pressure carrying branch 20, and hence the seal 24, compression against the conduit (not shown), see FIG. 11. Because the seal 24 is substantially inside port 18d, said port 18d prevents the seal 24 from extruding when pressurized or compressed against the conduit. Advantageously, this arrangement of the seal 24 inside the port or inside diameter 18d, between the sealing end 20s of the pressure carrying branch 20 and the conduit (not show), allows the fastening tee assembly 10 of the present invention to be rated for pressures as high as 27,000 psi.

Preferably, an anti-rotation means 22 is provided to ensure that the cope of the pressure carrying branch's 20 sealing end 20s remains properly aligned with the main run of conduit (not shown). Advantageously, the anti-rotation means 22 will also allow an operator to tighten a valve on the pressure carrying branch 20 (preferably said branch 20 has an externally treaded portion, as shown in FIGS. 3, 6, and 9-11, to facilitate attachment of a valve).

### First Embodiment

Referring to FIGS. 2-4, a first embodiment of the fastening tee assembly 10 of the present invention is shown. This embodiment of the fastening tee assembly 10 comprises a non-pressure branch 18 which is an integral part of the top shell 12, by being welded thereto. This embodiment further comprises a key-and-groove anti-rotation means 22, and lateral tabs 12t, 14t on the top and bottom shells 12, 14 (where the plurality of holes 28 for receiving bolts 16b there-through are located).

The anti-rotation means 22 of this embodiment comprises a tab or key 30 projecting from the shaft 20b of the pressure carrying branch 20 and a matching key-way or groove 32 in the internal diameter or port 18d of the non-pressure branch 18. Typically, and so as to allow for sealing of the assembly 10 against a high-pressure piping system, the key-way or groove 32 does not extend all the way along the longitudinal axis of the internal diameter or port 18d, but rather only extends partially from the top of the non-pressure branch 18. Likewise the key or tab 30 is also only of a certain limited length along the axis of the shaft 20b.

### Second Embodiment

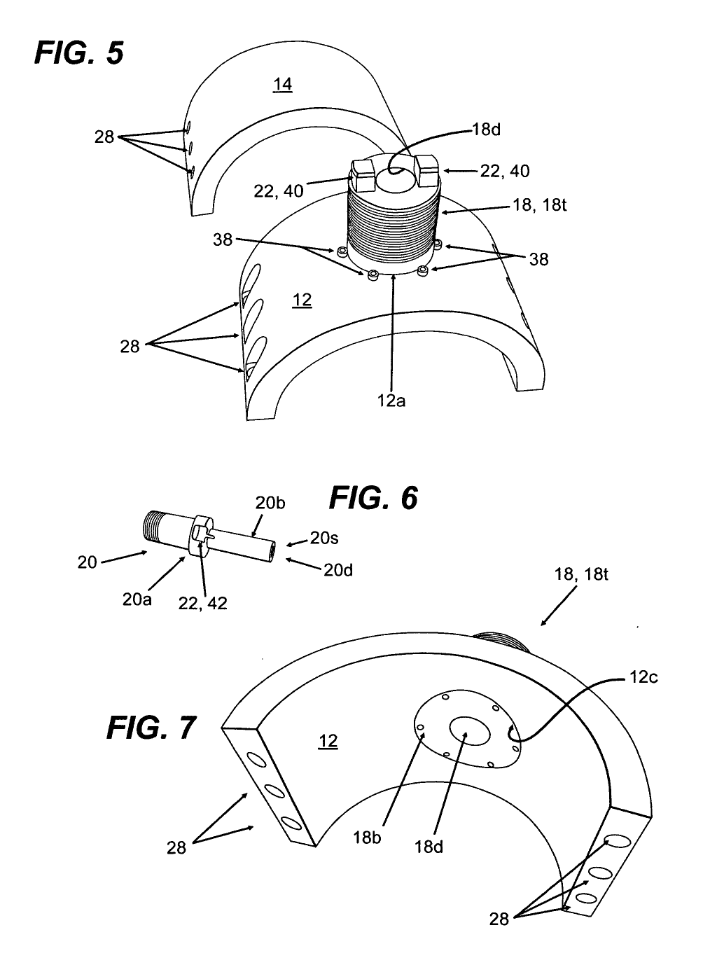

Referring to FIGS. 5-11, a second embodiment of the fastening tee assembly 10 of the present invention is shown. This embodiment of the fastening tee assembly 10 comprises a non-pressure branch 18 which is not an integral part of the top shell 12, but instead passes through an aperture 12a in said shell 12, preferably at a close tolerance, and is mounted in place by bolts or Allen screws 38. This embodiment of the assembly 10 further comprises a dog-and-recess anti-rotation means 22.

In particular this embodiment the top shell 12 comprises an aperture 12a having a shoulder 12c, and the non-pressure branch 18 comprises an end 18b with a slightly enlarged outside diameter; the remainder of the branch's 18 outside diameter is of such size so as to fit through the top shell's aperture 12a. Accordingly, the non-pressure branch 18 is mounted to the top shell 12 by being inserted through the aperture 12a until the branch's enlarged diameter 18b catches on the shoulder 12c, at which point the screws 38 are utilized to retain the two pieces 12, 18 together (see FIGS. 5 and 7).

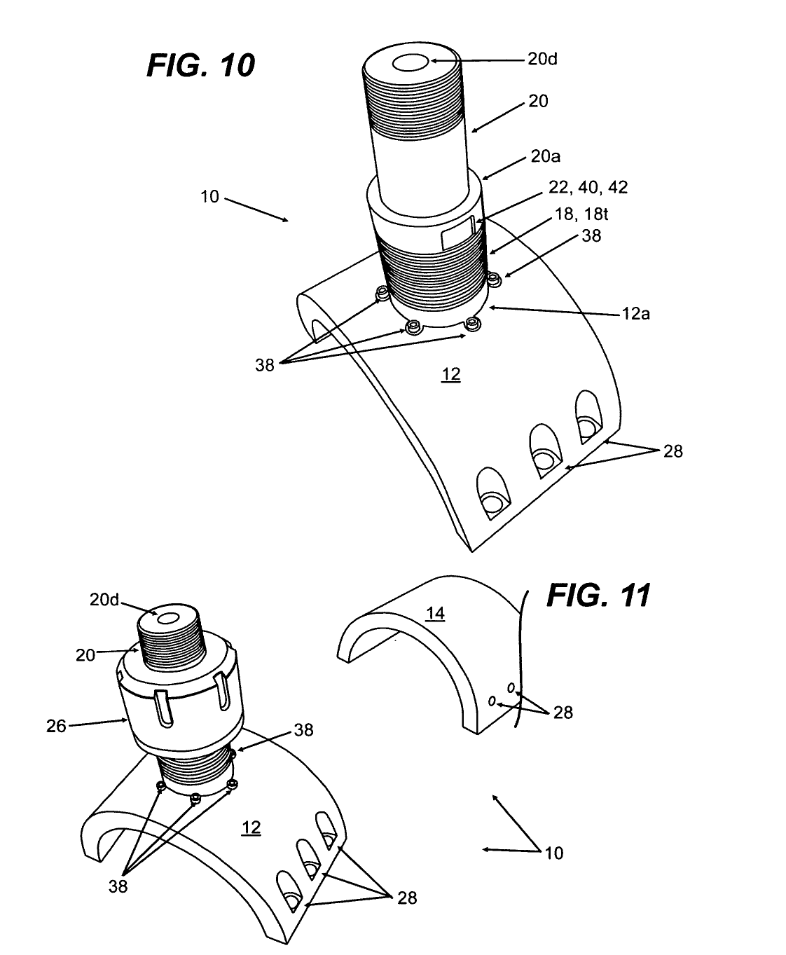

The non-pressure branch 18 further comprises one or more dogs or tabs 40 projecting axially from the end of the branch 18 opposite the enlarged diameter 18b (see FIGS. 5 and 9). The pressure carrying branch 20 comprises one or more recesses 42, located in the shoulder portion 20a, so as to match or cope with the one or more dogs 40 of the non-pressure branch 18 (see FIG. 10). This embodiment of the anti-rotation means 22 is stronger than that of the first embodiment.

This embodiment of the assembly 10, lacks the lateral tabs 12t, 14t of the first embodiment and is therefore lighter than the first embodiment. This embodiment also does not require the welding of the non pressure branch 18 to the top shell 12, thereby making manufacturing of the assembly easier and more efficient.

### Third Embodiment

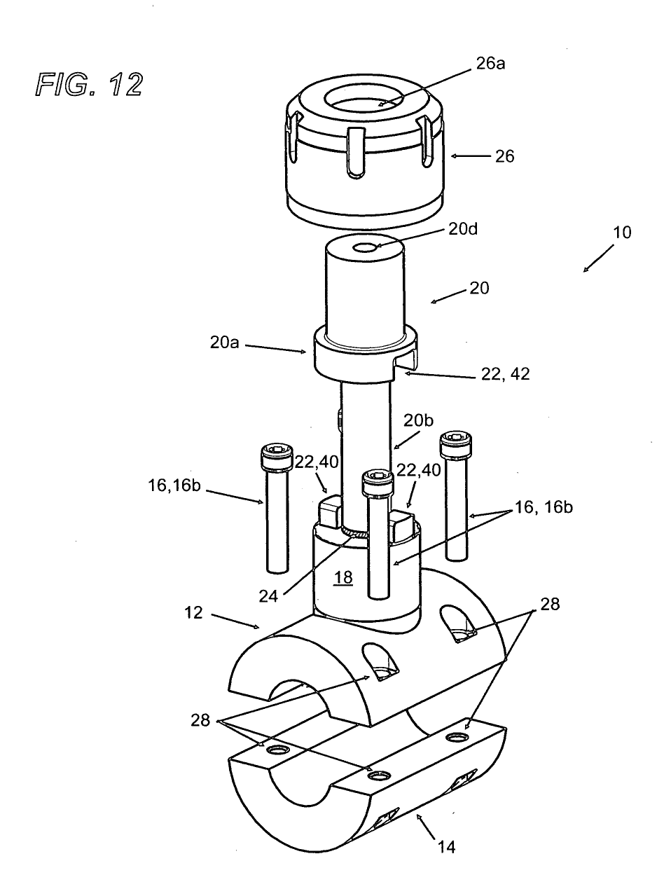

Referring to FIGS. 12-24d, a third embodiment of the fastening tee assembly 10 of the present invention is shown. This embodiment of the fastening tee assembly 10 is similar to the second embodiment, the major difference being that it has fewer holes 28 in the top and bottom shells 12, 14 and said shells 12, 14 are configured to clamp or mount around a smaller diameter conduit (not shown) than that of the second embodiment.

The specific embodiments described should be taken as illustrative of the invention only and not as limiting its scope. Many further modifications and changes will readily occur to those skilled in the art to which the invention relates and the inventions should be construed in accordance with the accompanying claims.

The embodiments of the invention in which an exclusive property or privilege is being claimed are defined as follows:

1. A fastening tee assembly for use on a conduit, the conduit generally having pressurized contents, the assembly comprising:
a first shell having a port therethrough;
a second shell;
fastening means to fasten said first and second shells around the conduit;
a pressure carrying branch suitable for insertion through the first shell's port and having a sealing end and an inside passage, said inside passage suitable for accepting a drill or hot tap machine therethrough;
a seal suitable for creating a sealing engagement between the pressure carrying branch's sealing end and the conduit; and
engagement means to maintain the sealing engagement between the pressure carrying branch's sealing end and the conduit.

2. The assembly of claim 1 wherein the engagement means further comprises:
a neck projecting from the first shell and forming said port, the neck having a threaded end;
a shoulder portion on said pressure carrying branch; and
a locking collar having an internally threaded portion suitable for threading on the neck's threaded end and further having an aperture of such dimensions so as to allow axial passage of substantially all the pressure carrying branch therethrough with the exception of the shoulder portion.

3. The assembly of claim 2 wherein the neck is an integral part of the first shell.

4. The assembly of claim 2 wherein the neck is a separate component shaped so as to substantially mount through an aperture in the first shell.

5. The assembly of claim 4 further comprising:
a second shoulder associated with the aperture in the first shell; and
an enlarged outside diameter portion on said neck;
wherein when the neck is mounted through the first shell's aperture said enlarged outside diameter catches on said second shoulder.

6. The assembly of claim 1 further comprising anti-rotation means.

7. The assembly of claim 6 wherein the anti-rotation means comprises a tab projecting from the pressure carrying branch and a matching groove in the port of the first shell.

8. The assembly of claim 6 wherein the anti-rotation means comprises at least one dog projecting axially from the neck and the pressure carrying branch further comprises at least one recess suitable for coping with said dog.

9. The assembly of claim 1 wherein the fastening means comprises bolt means and a plurality of matching and aligning holes through said first and second shells, wherein, said holes are suitable for receiving said bolt means.

10. A shell for use with a fastening tee assembly, the shell comprising:
a port suitable for accepting a pressure carrying branch;
a neck projecting from the shell and forming said port, the neck having a threaded end.

11. The shell of claim 10 wherein the neck is an integral part of the shell.

12. The shell of claim 10 wherein the neck is a separate component shaped so as to substantially mount through an aperture in the shell.

13. The assembly of claim 12 further comprising:
a second shoulder associated with the aperture in the shell; and
an enlarged outside diameter portion on said neck;
wherein when the neck is mounted through the shell's aperture said enlarged outside diameter catches on said second shoulder.

14. A method of creating a seal between a conduit and a tubular member, said conduit having a pressurized contents and said tubular member having a sealing end, the method comprising the steps of:
providing at least one shell suitable for engaging the conduit, said shell having a port therethrough;
providing a seal suitable for creating a sealing engagement between the tubular member's sealing end and the conduit;
fastening the shell against the conduit;
inserting the seal and the tubular member through the port so that the seal is positioned between the conduit and the tubular member's sealing end;
creating a sealing engagement between the tubular member's sealing end and the conduit; and
maintaining said sealing engagement for a desired length of time.

15. The method of claim 14 wherein the seal is positioned substantially inside the port when said sealing engagement is created.
